(19) United States
(12) Patent Application Publication
(10) Pub. No.: US 2003/0203755 A1
(43) Pub. Date: Oct. 30, 2003

(54) Encryption in a secure computerized gaming system

(75) Inventor: Mark D. Jackson, Fort Collins, CO (US)

Correspondence Address: MARK A. LITMAN & ASSOCIATES, P.A., York Business Center, Suite 205, 3209 W. 76th St., Edina, MN, 55435, US

(73) Assignee: Shuffle Master, Inc.

(21) Appl. No.: 10/134,657

(22) Filed: Apr. 25, 2002

(51) Int. Cl. A63F 13/00

(52) U.S. Cl. 463/42

(57) ABSTRACT

The present invention provides an architecture and method for a gaming-specific platform that features secure storage and verification of game code and other data, provides the ability to securely exchange data with a computerized wagering gaming system, and does so in a manner that is straightforward and easy to manage. Some embodiments of the invention provide the ability to identify game program code as certified or approved, such as by the Nevada Gaming Regulations Commission or other regulatory agency. The invention provides these and other functions by encrypting a random number, storing the encrypted random number, and hashing the random number and a casino game data set to provide a first bit string, and storing the first bit string.

### BACKGROUND OF THE ART

1. Field of the Invention

The invention relates generally to computerized wagering game systems, and more specifically to the use of encryption and hash functions to ensure security in a computerized wagering game system.

2. Background of the Invention

Games of chance have been enjoyed by people for thousands of years and have enjoyed increased and widespread popularity in recent times. As with most forms of entertainment, players enjoy playing a wide variety of games and new games. Playing new games adds to the excitement of “gaming.” As is well known in the art and as used herein, the term “gaming” and “gaming devices” are used to indicate that some form of wagering is involved, and that players must make wagers of value, whether actual currency or some equivalent of value, e.g., token or credit.

One popular game of chance is the slot machine. Conventionally, a slot machine is configured for a player to wager something of value, e.g., currency, house token, established credit or other representation of currency or credit. After the wager has been made, the player activates the slot machine to cause a random event to occur. The player wagers that particular random events will occur that will return value to the player. A standard device causes a plurality of reels to spin and ultimately stop, displaying a random combination of some form of indicia, for example, numbers or symbols. If this display contains one of a preselected plurality of winning combinations, the machine releases money into a payout chute or increments a credit meter by the amount won by the player. For example, if a player initially wagered two coins of a specific denomination and that player achieved a payout, that player may receive the same number or multiples of the wager amount in coins of the same denomination as wagered.

There are many different formats for generating the random display of events that can occur to determine payouts in wagering devices. The standard or original format was the use of three reels with symbols distributed over the face of each reel. When the three reels were spun, they would eventually each stop in turn, displaying a combination of three symbols (e.g., with three reels and the use of a single payout line as a row in the middle of the area where the symbols are displayed.) By appropriately distributing and varying the symbols on each of the reels, the random occurrence of predetermined winning combinations can be provided in mathematically predetermined probabilities. By clearly providing for specific probabilities for each of the preselected winning outcomes, precise odds that would control the amount of the payout for any particular combination and the percentage return on wagers for the house could be readily controlled.

Other formats of gaming apparatus that have developed in a progression from the pure slot machine with three reels have dramatically increased with the development of video gaming apparatus. Rather than have only mechanical elements such as wheels or reels that turn and stop to randomly display symbols, video gaming apparatus and the rapidly increasing sophistication in hardware and software have enabled an explosion of new and exciting gaming apparatus. The earlier video apparatus merely imitated or simulated the mechanical slot games in the belief that players would want to play only the same games. Early video games therefore were simulated slot machines. The use of video gaming apparatus to play new games such as draw poker and Keno broke the ground for the realization that there were many untapped formats for gaming apparatus. Now casinos may have hundreds of different types of gaming apparatus with an equal number of significant differences in play. The apparatus may vary from traditional three reel slot machines with a single payout line, video simulations of three reel video slot machines, to five reel, five column simulated slot machines with a choice of twenty or more distinct pay lines, including randomly placed lines, scatter pays, or single image payouts. In addition to the variation in formats for the play of games, bonus plays, bonus awards, and progressive jackpots have been introduced with great success. The bonuses may be associated with the play of games that are quite distinct from the play of the original game, such as the video display of a horse race with bets on the individual horses randomly assigned to players that qualify for a bonus, the spinning of a random wheel with fixed amounts of a bonus payout on the wheel (or simulation thereof), or attempting to select a random card that is of higher value than a card exposed on behalf of a virtual dealer.

Examples of such gaming apparatus with a distinct bonus feature includes U.S. Pat. Nos. 5,823,874; 5,848,932; 5,863,041; U.K. Patent Nos. 2 201 821 A; 2 202 984 A; and 2 072 395A; and German Patent DE 40 14 477 A1. Each of these patents differ in fairly subtle ways as to the manner in which the bonus round is played. British patent 2 201 821 A and DE 37 00 861 A1 describe a gaming apparatus in which after a winning outcome is first achieved in a reel-type gaming segment, a second segment is engaged to determine the amount of money or extra games awarded. The second segment gaming play involves a spinning wheel with awards listed thereon (e.g., the number of coins or number of extra plays) and a spinning arrow that will point to segments of the wheel with the values of the awards thereon. A player will press a stop button and the arrow will point to one of the values. The specification indicates both that there is a level of skill possibly involved in the stopping of the wheel and the arrow(s), and also that an associated computer operates the random selection of the rotatable numbers and determines the results in the additional winning game, which indicates some level of random selection in the second gaming segment. U.S. Pat. Nos. 5,823,874 and 5,848,932 describe a gaming device comprising:

a first, standard gaming unit for displaying a randomly selected combination of indicia, said displayed indicia selected from the group consisting of reels, indicia of reels, indicia of playing cards, and combinations thereof; means for generating at least one signal corresponding to at least one select display of indicia by said first, standard gaming unit; means for providing at least one discernible indicia of a mechanical bonus indicator, said discernible indicia indicating at least one of a plurality of possible bonuses, wherein said providing means is operatively connected to said first, standard gaming unit and becomes actuatable in response to said signal. In effect, the second gaming event simulates a mechanical bonus indicator such as a roulette wheel or wheel with a pointing element.

A video terminal is another form of gaming device. Video terminals operate in the same manner as conventional slot or video machines except that a redemption ticket is issued rather than an immediate payout being dispensed.

The vast array of electronic video gaming apparatus that is commercially available is not standardized within the industry or necessarily even within the commercial line of apparatus available from a single manufacturer. One of the reasons for this lack of uniformity or standardization is the fact that the operating systems that have been used to date in the industry are primitive. As a result, the programmer must often create code for each and every function performed by each individual apparatus. To date, no manufacturer prior to the assignee of the present invention is known to have been successful in creating a universal operating system for converting existing equipment (that includes features such as reusable modules of code) at least in part because of the limitations in utility and compatibility of the operating systems in use. When new games are created, new hardware and software is typically created from the ground up.

At least one attempt has been made to create a universal gaming engine that segregates the code associated with random number generation and algorithms applied to the random number string from the balance of the code. Carlson U.S. Pat. No. 5,707,286 describes such a device. This patentee recognized that modular code would be beneficial, but only contemplated making RNG and transfer algorithms modular.

The lack of a standard operating system has contributed to maintaining an artificially high price for the systems in the market. The use of unique and non-standardized hardware interfaces in the various manufactured video gaming systems is a contributing factor. The different hardware, the different access codes, the different pin couplings, the different harnesses for coupling of pins, the different functions provided from the various pins, and the other various and different configurations within the systems has prevented any standard from developing within the technical field. This is advantageous to the apparatus manufacturer, because the games for each system are provided exclusively by a single manufacturer, and the entire systems can be readily obsoleted, so that the market will have to purchase a complete unit rather than merely replacement software. Also, competitors cannot easily provide a single game that can be played on different hardware. A solution to this problem is presented in our co-pending application for Video Gaming Apparatus for Wagering with Universal Computerized Controller and I/O Interface for Unique Architecture, assigned Ser. No. 09/405,921, and filed Sep. 24, 1999, the disclosure that is incorporated herein by reference.

The invention of computerized gaming systems that include a common or universal video wagering game controller that can be installed in a broad range of video gaming apparatus without substantial modification to the game controller has made possible the standardization of many components and of corresponding gaming software within gaming systems. Such systems desirably will have functions and features that are specifically tailored to the unique demands of supporting a variety of games and gaming apparatus types, and will do so in a manner that is efficient, secure, and cost-effective.

In addition to making communication between a universal operating system and non-standard machine devices such as coin hoppers, monitors, bill validators and the like possible, it would be desirable to provide security features that enable the operating system to verify that game code and other data has not changed during operation.

Alcorn et al. U.S. Pat. No. 5,643,086 describes a gaming system that is capable of authenticating an application or game program stored on a mass media device such as a CD-ROM, RAM, ROM or other device using hashing and encryption techniques. The mass storage device may be located in the gaming machine, or may be external to the gaming machine. This verification technique therefore will not detect any changes that occur in the code that is executing because it tests the code residing in mass storage prior to loading into RAM. The authenticating system relies on the use of a digital signature and suggests hashing of the entire data set during the encryption and decryption process. See also, Alcorn et al. U.S. Pat. No. 6,106,396 and Alcorn et al. U.S. Pat. No. 6,149,522. U.S. patent application Ser. No. 09/949,021, filed Sep. 7, 2001, and titled “ENCRYPTION IN A SECURE COMPUTERIZED GAMING SYSTEM” discloses an encryption/authentication system wherein a computerized game controller having a processor, memory, and nonvolatile storage and operable to control the computerized wagering game; and game data stored in the nonvolatile storage, wherein the game data stored in nonvolatile storage is verified during operation. Additionally disclosed is a gaming system comprising: a nonvolatile memory; an encrypted control file stored in the nonvolatile memory, the encrypted control file including a set of program files, a message authentication code unique to each program file, and a message authentication code key; a gaming controller, wherein the gaming controller operates to decrypt the encrypted control file and authenticate the gaming program files during operation of the gaming system; and gaming system devices in communication with the gaming controller via a gaming system interface.

That system may further comprise a message authentication code process stored in memory, wherein the game controller authenticates the set of program files by applying the message authentication process using the set of program files and the message authentication code key to provide a set of complementary message authentication codes, and comparing the message authentication codes from the control file to the complementary message authentication codes. Additionally, the system may have the message authentication process stored in read only memory. Also disclosed is a computer-readable medium having computer-executable instructions for performing a method of preparing a game data set capable of authentication comprising: providing a game data set; determining a message authentication code unique to the game data set; and storing the game data set and the message authentication code; and a computer-readable medium having computer-executable instructions for performing a method of authenticating a game used in a gaming system comprising: receiving an encrypted control file; decrypting the encrypted control file to provide a control file, the control file including a set of program filenames giving ordering information, a set of message authentication codes including a message authentication code unique to each program file, and a message authentication code key; and using the original control file to verify authentication of the game.

What is still desired is alternative architecture and methods providing a gaming-specific platform that features secure storage and verification of game code and other data, provides the ability to securely change game code on computerized wagering gaming system, and has the ability to verify that the code has not changed during operation of the gaming machine.

It is further desired that the game program code be identifiable as certified or approved, such as by the various gaming regulation commissions such as the Nevada Gaming Regulations Commission, New Jersey Gaming Regulations Commission or other regulatory agency.

### SUMMARY OF THE INVENTION

The present invention provides an architecture and method for a wagering game-specific platform that features secure storage and verification of game code and other data, provides the ability to securely exchange data with a computerized wagering gaming system and/or network system, and does so in a manner that is straightforward and easy to manage. Some embodiments of the invention provide the ability to identify game program code as certified or approved by state Gaming Regulations Commission or other regulatory agencies. The invention provides these and other functions by use of encryption, hash functions as well as other cryptographic methods. Such functions are advantageously applied to data loaded into RAM and occur while the gaming machine is in operation.

In one embodiment the present invention provides a method of preparing a game data set stored in a gaming apparatus capable of authentication. The method includes providing a game data set. The game data set (this term is defined in greater detail later) that is to form the basis of an (or the) authentication step is converted into a form that assists in its authentication, and then this converted form of the game data set is authenticated using information stored on storage media that is part of the gaming apparatus. A message authentication code unique to the game data set is determined by selecting a random number and combining the random number with the game data set using a key-dependent hash function to form a first key-dependent bit string. The random number is also separately encrypted and stored in storage media as an encrypted random number. The hashed combination of game data set and the random number is also stored on storage media. These stored values are then used in an authentication program to authenticate the game data set.

In another embodiment, the present invention provides a method of authenticating a game used in a gaming system. The method includes receiving the encrypted random number produced in the preparation step described above, and decrypting that encrypted random number. The decrypted random number (now the original random number) is then utilized in a key dependent hash function with the game data set that is to be authenticated to generate a second key-dependent bit string. The first key-dependent bit string and the second key-dependent bit string are then compared. If the two bit strings are equal (or identical in pattern), the game data set has been authenticated and the gaming apparatus may be played. If the two bit strings are different (e.g., unequal in a number of digits or dissimilar in pattern), the game data set has failed its test for authentication, and the gaming apparatus will not continue play, and a signal should be provided to alert management that a fault has been detected in game data set information or other machine functionality.

In another embodiment, the present invention provides a gaming system. The gaming system includes a nonvolatile memory. A game data set authentication program as described above is embedded in the gaming apparatus so that the preparation process and authentication process can be performed to control play on the gaming apparatus to assure security of the gaming apparatus. A game controller is provided, wherein the game controller operates to selectively authenticate the game data set during operation of the gaming system.

In another embodiment, a device such as an In-Circuit Validator such as that described in copending U.S. Provisional Patent Application Serial No. 60/318,369 filed on Sep. 10, 2001 (which reference is incorporated herein in its entirety by reference) can be used to quickly perform the hashing part of the method, after the random number is provided to it by the gaming device.

### BRIEF DESCRIPTION OF THE FIGURES

FIG. 1 shows a computerized wagering game apparatus such as may be used to practice some embodiments of the present invention.

FIG. 2 shows a diagram of a networked computer connected to certain components comprising a portion of a computerized wagering game apparatus, consistent with some embodiments of the present invention.

FIG. 3 is a diagram of a process of preparing game set data for use in an authentication process of the invention.

FIG. 4 is a diagram of a process for authenticating a prepared game data set according to a practice of the present invention.

### DETAILED DESCRIPTION OF THE INVENTION

In the following detailed description of embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention in various embodiments provides an architecture and method for a universal operating system that features secure storage and verification of game code and other data, provides the ability to securely exchange data with a computerized wagering gaming system, and does so in a manner that is straightforward and easy to manage. Some embodiments of the invention provide the ability to identify game program code as certified or approved, such as by the Nevada Gaming Commission, New Jersey Gaming Commission or other regulatory agency. The invention provides these and other functions by use of encryption, including digital signatures, random numbers and hash functions as well as other encryption methods to data being executed. Because hash functions and other encryption methods are employed widely in the present invention, they are introduced and discussed here.

“Hash functions” for purposes of this disclosure are a type of function that generates an abbreviated data bit string, typically of fixed length from variable strings of characters or text. The data string generated is typically substantially smaller than the text string itself, but is long enough that it is unlikely that the same number will be produced by the hash function from different strings of text. The formula employed in the hash function must also be chosen such that it is unlikely that different text strings will produce the same hash value. An example of a suitable hash function is a 160 bit SHA hash function which (secure hash algorithm), regardless of file size, always produces a hash value that will be 160 bits in length.

The hashed data string is commonly referred to as a “message digest.” A message digest can be stored for future use, or encrypted and then stored in nonvolatile memory, for example.

Hash functions are often used to hash data records to produce unique numeric values corresponding to each data record in a database, which can then be applied to a search string to reproduce the hash value. The hash value can then be used as an index key, eliminating the need to search an entire database for the requested data. Some hash functions are known as one-way hash functions, meaning that with such a function it is extremely difficult to derive a text string that will produce a given hash value, but relatively easy to produce a hash value from a text string. This ensures that it is not feasible to modify the content of the text string and produce the same hash value or any predictable hash value, for that matter.

Such a function can be used to hash a given character string and produce a first hash value that can later be compared to a second hash value derived from the same character string, to ensure the character string has not changed. If the character string has been altered, the hash values produced by the same hash function will be different. The integrity of the first hash value can be protected against alteration by use of other encryption methods as is done with digital signatures.

Digital signatures are employed to sign electronic documents or character strings, and ensure that the character string has not been altered since signing. Digital signatures typically are employed to indicate that a character string was intentionally signed with an unforgeable signature that is not reusable with another document, and that the signed document is unalterable. The digital signing mechanism or method is designed to meet these criteria, typically by using complex mathematical encryption techniques.

One example is use of a public key/private key encryption system to sign a document. In a public key/private key system a user has a pair of keys, which may be used alternately to encrypt or decrypt a document. The public key is published or distributed in a manner that reasonably ensures that the key in fact belongs to the key owner, and the private key is kept strictly secret. If someone wishes to send a character string that only a certain person may read, the character string is encrypted before sending using the intended reader's public key. The character string is then visible only to the intended reader by using their private key to decrypt the character string.

However, if a user wishes to send a character string in such a manner that the document is virtually guaranteed to be the authentic document created by the sender but essentially anyone can read it, the user can sign the document by encrypting it with his private key before sending. Anyone can then decrypt the document with the signer's public key which is typically widely distributed, and can thereby verify that the character string was signed by the key pair owner. This example embodiment provides authentication through encryption, ensuring that a character string has not been altered.

Because encryption of large character strings such as large computer programs or long text documents can require a substantial amount of time to encrypt and decrypt, some digital authentication mechanisms implement one-way hash functions. In one such embodiment, the signer uses a known one-way hash algorithm to create a hash value for the character string, and encrypts the hash value with his private key. The document and signed hash value are then sent to the recipient, who runs the same hash function on the character string and compares the resulting hash value with the hash value produced by decrypting the signed hash value with the signer's public key. Such a method provides very good security, as long as the hash function and encryption algorithm employed are suitably strong.

Encryption of data via a public key/private key system is useful not only for producing digital signatures, but also for encryption of data before sending or storing the data or to keep data secure or secret in other applications. Similarly, symmetric encryption techniques which rely on encryption and decryption of the same single secret key may be applied to such applications. For example, transmission of program data between a network server and a computerized wagering game apparatus may be secured via a symmetric encryption technique, and the program data received in the game apparatus may be verified as approved by a regulatory agency via a digital signature employing hash functions and public key cryptography before execution.

Other encryption methods and formulas exist, and are also usable consistent with the present invention. Some symmetric encryption methods, such as DES (Data Encryption Standard) and its variants rely on the secrecy of a single key. A variety of other encryption methods, such as RSA and Diffie-Hellman are consistent with public/private key methods. Various hash functions may be employed, such as MD5 or SHA, and will be useful in many aspects consistent with the present invention so long as they are sufficiently nonreversible to be considered one-way hash functions. Various encryption methods will also provide varying degrees of security, from those that are relatively easy to defeat to those that are extremely difficult to defeat. These various degrees of security are to be considered within the scope of encryption methods consistent with this application, including various degrees of security that may to varying degrees of probability make encrypted data unforgeable, unreadable, or the like. A variety of encryption methods exist and are expected to be developed in the future, all of which are likely to be employable in some aspect consistent with the present invention, and are within the scope of the invention.

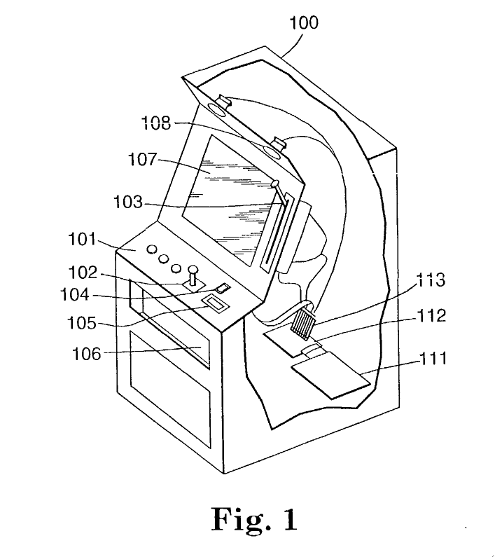

FIG. 1 shows an exemplary gaming system 100, illustrating a variety of components typically found in gaming systems and how they may be used in accordance with the present invention. User interface devices in this gaming system include push buttons 101, joystick 102, and pull arm 103. Credit for wagering may be established via coin or token slot 104, a device 105 such as a bill receiver or card reader, or any other credit input device. A card reader 105 may also provide the ability to record credit information on a user's card when the user has completed gaming, or credit may be returned via a coin tray 106 or other credit return device such as a ticket reader/printer. Information is provided to the user by devices such as video screen 107, which may be a cathode ray tube (CRT), liquid crystal display (LCD) panel, plasma display, light-emitting diode (LED) display, or other display device that produces a visual image under control of the computerized game controller. Also, buttons 101 may be illuminated to indicate what buttons may be used to provide valid input to the game system at any point in the game. Still other lights or other visual indicators may be provided to indicate game information or for other purposes such as to attract the attention of prospective game users. Sound is provided via speakers 108, and also may be used to indicate game status, to attract prospective game users, or for other purposes, under the control of the computerized game controller.

The gaming system 100 further comprises a computerized game controller 111 and I/O interface 112, connected via a wiring harness 113. The universal game controller 111 need not have its software or hardware designed to conform to the interface requirements of various gaming system user interface assemblies, but can be designed once and can control various gaming systems via I/O interfaces 112 designed to properly interface an input and/or output of the universal computerized game controller to the interface assemblies found within the various gaming systems.

In some embodiments, the universal game controller 111 is a standard IBM Personal Computer-compatible (PC compatible) computer. Still other embodiments of a universal game controller comprise general purpose computer systems such as embedded controller boards or modular computer systems. Examples of such embodiments include a PC compatible computer with a PC/104 bus, which is an example of a modular computer system that features a compact size and low power consumption while retaining PC software and hardware compatibility. The universal game controller provides all functions necessary to implement a wide variety of games by loading various program code on the universal controller, thereby providing a common platform for game development and delivery to customers for use in a variety of gaming systems. Other universal computerized game controllers consistent with the present invention may include any general-purpose computers that are capable of supporting a variety of gaming system software, such as universal controllers optimized for cost effectiveness in gaming applications or that contain other special-purpose elements yet retain the ability to load and execute a variety of gaming software.

In yet other embodiments, the universal controller with security features can be used for other applications, including controlling networked in-line systems such as progressive controllers and player tracking systems. The invention can also be used for kiosk displays and creating picture in picture features on a video display.

The universal computerized game controller of some embodiments is a computer running an operating system with a gaming application-specific kernel such as a customized Linux kernel. In further embodiments, a system handler application layer of code executes within the kernel, further providing common game functionality to the programmer. The game program in such embodiments is therefore only a fraction of the total code, and relies on the system handler application layer and kernel to provide commonly used gaming functions. Still other embodiments will have various levels of application code, ranging from embodiments containing several layers of game-specific code to a single-layer of game software running without an operating system or kernel but providing its own computer system management capability.

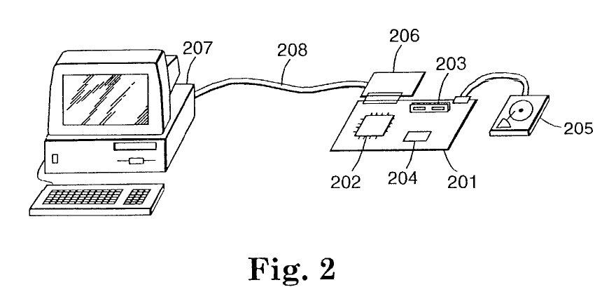

FIG. 2 illustrates a networked computer connected to selected items that comprise a part of a computerized wagering game apparatus, as are used in various embodiments of the present invention. The computerized game controller 201 has a processor 202, memory 203, and nonvolatile memory 204. One example of nonvolatile memory is a flash disk. The flash disk is a mass storage device that is advantageously read/write, yet retains information stored on disk upon power down. Attached to the computerized game controller of some embodiments is a mass storage device 205, and a network interface adaptor 206. The network interface adaptor is attached to a networked computer 207 via network connection 208. The various components of FIG. 2 exist within embodiments of the invention, and are illustrated to show the manner in which the various components are associated.

The computerized wagering game controller of the invention is operable to control a computerized wagering game, and is operable to employ encryption in various embodiments to provide data security. The computerized game controller 201 in some embodiments is a general-purpose computer, such as an IBM PC-compatible computer. The game controller may execute an operating system, such as Linux or Microsoft Windows, which in further embodiments is modified to execute within the computerized gaming apparatus. The computerized game controller also executes game code, which may be loaded into memory 203 from either a mass storage device 205 such as a hard disc drive, or nonvolatile memory 204 such as flash memory or EPROM memory before execution. In some embodiments, the computerized game controller 201 loads encryption functions into memory 203, and those functions are subsequently executed to securely load other gaming system data from the mass storage device 205.

In further embodiments, the computerized game controller exchanges data with a networked computer 207 via a network connection 208 and a network interface adapter 206. Data exchanged via the network connection is encrypted in some embodiments of the invention, to ensure security of the exchanged data. The data to be exchanged in various embodiments comprises game program data, computerized gaming apparatus report data, data comprising commands to control the operation of the computerized gaming apparatus, and other computerized gaming apparatus data. The networked computer 207 in one example of the invention is a centralized casino computer. Employing encryption in exchanging such data provides a degree of security, ensuring that such data is not altered or forged.

The invention employs encryption, including hash functions, symmetric encryption, and public key/private key encryption in various embodiments, which provides a degree of confidence that data utilized by the computerized gaming system and protected by encryption in accordance with the invention is not altered or forged. The data within the scope of the invention includes but is not limited to data comprising programs such as operating system or game program data, computerized gaming machine status data such as credits or other game state data, control instruction data for controlling the operation of the computerized gaming apparatus, and other computerized gaming machine data.

The essential objective of authentication programs is to provide near absolute assurance that data stored in memory has not been corrupted, violated, altered or otherwise changed from the original data placed into memory. All of the authentication programs therefore must act to provide a first set of casino game data information to which a present set of casino game data can be compared. The variations in the various known authentication programs treat the original data differently, compare different forms of the data, use different encryption techniques, form different stored data forms (e.g., signatures, abbreviated bit strings, etc.) representing the casino game data set, and perform other steps and use other features with the underlying objective remaining the same: an original cache of information must be shown to remain the same by later comparing evidence (data) of the original information (its content and/or state) to data relating to the present state and/or content of the data. Variations in the methods of these comparisons are desirable as the variations assist in dissuading security breaches as different programs would require different efforts and techniques to avoid them. By providing a wide variety of different authentication systems, the breach of any single system is complicated.

One embodiment of the invention comprises the use of hash functions to calculate a reference hash value (a first abbreviated or key-dependent bit string, which may or may not be encrypted) for selected data (in this case a combination of a random number and a casino game data set), which can later be compared to a new hash value (a second abbreviated or key-dependent bit string) calculated from the same casino game data set and a decrypted random number generated from a stored, encrypted random number. The hash functions employed will desirably but not necessarily be one-way hash functions, to provide a greater degree of certainty that the reference hash value cannot be used in reverse to produce corresponding altered data. In a further embodiment, the data is hashed repeatedly by a continuously executing program thread that ensures that the data is not altered during the course of operation of the computerized wagering game. In another embodiment, an In-Circuit Validator may be used to perform the hashing in a separate device apart from the game controller itself. The data that is continuously hashed is in some embodiments is continuously hashed after being loaded into memory 203 for use by the computerized game controller.

If the reference hash value and the calculated hash value (e.g., the first key-dependent bit string and the second key-dependent bit string) do not match, the computerized gaming apparatus will desirably provide some indication of the hash failure. In one embodiment, the game is brought to a locked or “tilt” state that prevents wagering upon a hash check failure. In a further embodiment, notification of the hash failure is sent to a networked computer 207 to alert the computer's user of the hash failure. In some embodiments, the computerized wagering game apparatus provides limited function to check the status of the game, including in further embodiments functions accessible only by operating controls within the computerized wagering game apparatus secure housing.

In one embodiment, the operating system as described in the copending application for Computerized Gaming System, Method and Apparatus, having Ser. No. 09/520,405 and filed on the Mar. 8, 2000, cooperates with a library of “shared objects” that are specific to the game application. For purposes of this disclosure, a “shared object” is defined as self-contained, functional units of game code that define a particular feature set or sequence of operation for a game. The personality and behavior of a gaming machine of the present invention are defined by the particular set of shared objects called and executed by the operating system. Within a single game, numerous shared objects may be dynamically loaded and executed. This definition is in contrast with the conventional meaning of a shared object, which typically provides an API to multiple programs. An API is an application Programming Interface, and includes a library of functions.

The shared object code, as well as other data may be verified according to one embodiment of the present invention by first preparing a first bit string (e.g., abbreviated or key-dependent) from data (e.g., casino game data set(s)). The bit string may be prepared by first hashing the data set and the random number (e.g., generated by a random number generating capacity normally in gaming apparatus or by a random number generating function separately provided for authentication) to create a first bit string. The first bit string does not have to be encrypted (but it may be encrypted, if desired, via an encryption program that is stored on ROM utilizing a private/public key algorithm). If the first bit string is encrypted, this would form a unique signature that would have to be decrypted later, or else the second bit string would most likely have to be encrypted for comparison with the first bit string. The first bit string, if encrypted, may also be compared directly with the second bit string, and authentication would be provided by recognition of a stable value or mathematical relationship existing between the encrypted first bit string and unencrypted second bit string. An example of a specific embodiment of this alternative could include using two different random numbers in separate hashing operations. The resulting hash values could then be compared to determine (verify) if there was a definitive (but unequal) relationship between the two resulting hash values. In this way, attempts to breach security by attempting to find equal matches between resulting values would be additionally thwarted. There could be a verification function that compares the data to find a specific type of mathematical relationship between the results from the two distinct random numbers. In this manner, even if the function and first random number were discovered, the second random number must still be discovered to allow for verification. The data and bit string are then stored on a mass storage device such as a network storage device or internal memory capacity, e.g., EPROM, flash memory, hard drive, CD-ROM, RAM, flash disk or the like.

In one embodiment, the shared objects for a particular application and their corresponding signatures are stored in flash memory or on an EPROM. When the shared objects are called, they are copied into RAM, where they are hashed on a frequent periodic basis. The shared objects may be hashed from flash memory, or loaded into RAM and then hashed from RAM. Utilizing Linux, Unix or other similar operating system advantageously permits the location of data in RAM. Data verification in RAM has the distinct advantage that errors will be caught at the time they occur, rather than when the data is loaded or reloaded. This could save casinos untold amounts by avoiding the payment of jackpots and the like based on machine malfunction that was not promptly detected. Since hashing is a batch process, the process is not continuous. However, when the hashing takes relatively little time, such as 10 seconds for example, the process can repeat itself so that the data verification in RAM is in effect, continuous.

The bit string created from hashing the shared object is preferably unencrypted, as indicated above, but may be encrypted. If encrypted, a key is used to decrypt the message digest utilizing a first decryption program. The first bit string stored in flash memory, if encrypted is decrypted using a second decryption program via a public key (or private key) and the values are compared.

Although code verification of the gaming program shared objects has been described in detail above, code verification utilizing hash functions and signatures can be applied to verifying the authenticity of the linux kernel, modular modifications to the kernel, the operating system, the BIOS game state data, random number generation data and the like.

In various embodiments, selected data may be protected with encryption by signing the data with a digital signature that is verified to ensure integrity of the data. In some embodiments, the digital signature comprises signing the selected data with a signer's private key such that the data can only be decrypted by using the corresponding public key. Because only the intended signer knows his private key and documents encrypted with other private keys cannot be decrypted with the intended signer's public key, successful decryption of data with the intended signer's public key provides a degree of certainty that the data was signed or encrypted by the intended signer.

But, because public key/private key encryption algorithms typically take a relatively long time to encrypt large amounts of data, the encryption algorithm is more efficiently used in some embodiments to encrypt a unique characteristic of the data such as the hash value from a one-way hash function. In such an embodiment, the signer derives the reference hash value with a one-way hash function for the data to be signed, and encrypts the resulting hash value with his private key. One-way hash functions typically may be applied to data much more quickly than public key/private key algorithms, particularly if done by a separate piece of hardware such as an In-Circuit Validator (as described in the above incorporated by reference U.S. provisional application Serial No. 60/318,369, filed Sep. 10, 2001), and so it is more desirable to process the data to be authenticated with a hash function than directly with a public key/private key algorithm. In some embodiments of the invention, if encryption of the bit string combining the random number and the casino game data set is used, only the hash value needs to be encrypted with public key/private key encryption, greatly reducing the time needed to sign or verify large amounts of data. To verify the signature, the hash value is decrypted with the intended signer's public key and the decrypted reference hash value is compared to a newly-computed hash value of the same data. If the reference hash value matches the newly-computed hash value, a degree of certainty exists that the signed data has not been altered since it was signed.

In some embodiments using digital signatures, the digital signature is that of a regulatory agency or other organization responsible for ensuring the integrity of data in computerized wagering game systems. For example, the Nevada Gaming Regulations Commission may apply a signature to data used in such gaming systems, ensuring that they have approved the signed data. Such an embodiment will be useful to ensure that game code executing in these systems has been approved and not altered since approval, and provides security both to the game operator or owner and to the regulatory commission. In other embodiments, the digital signature is that of the game code manufacturer or designer, and ensures that the game code has not been altered from its original state since signing.

Secure storage of the reference hash values or public keys in the systems described above is important, because data can be more easily forged if the reference hash values or public keys used to verify the integrity of the data can also be altered. For this reason, the reference hash values, public keys, or other encryption key data is stored in nonwritable memory. In some embodiments, the nonwritable memory is an EPROM that is not programmable in the computerized wagering game apparatus. The nonwritable memory in such embodiments is reprogrammable, but reprogramming requires in various embodiments the use of special hardware, execution of restricted functions, or other secure methods. In other embodiments, the nonvolatile memory is a programmable memory that is not alterable, requiring replacement of the nonvolatile memory each time new encryption key data is needed. Such embodiments have the advantage that the nonwritable memory 204 must be physically removed and replaced to alter the data, providing a degree of access security and allowing visual verification of the identity of the nonvolatile memory and its contents.

In still other embodiments, the encryption key data is stored on the mass storage device. Further embodiments include storage of the encryption key data embedded in encryption functions, storage in secure areas of a hard disc drive mass storage device, or use of other security methods such as hardware dongles to protect the encryption key data.

These authentication or encryption methods in some embodiments of the invention are also applied to computerized gaming system communication over a network. Data communicated over a network is in various embodiments of the invention verified by use of a hash function, verified by use of public key/private key encryption, verified by use of symmetric encryption, verified by process similar or identical to usage of the random number encryption procedure described above or verified by use of digital signatures. Also, a variety of key exchange or key negotiation protocols exist which in some embodiments of the invention provide the capability for a networked computerized gaming system to publicly agree with another networked computer system on encryption keys that may be subsequently used to communicate securely over a network.

Such network communication methods are utilized in the invention to provide for secure exchange of data between computerized wagering game systems and other networked computer systems. For example, control commands that control certain aspects of the operation of the computerized wagering games are securely sent over a network in some embodiments of the invention. Such commands may include increasing odds of payout on selected computerized wagering game systems, or changing the game program that is executed on selected computerized wagering game systems, by way of non-limiting examples, at selected times of the day. The computerized wagering games in some embodiments securely report game data such as bookkeeping data to a networked computer via encryption. In still other embodiments of the invention, wagering game program data is securely transmitted over the network to the computerized wagering game systems, providing a secure way to provide new wagering games to the systems without physically accessing each computerized wagering game system. Various embodiments of the invention transmit other computerized wagering game data over a network connection via encryption, and are within the scope of the invention.

Because authentication and encryption methods typically provide a degree of security that is dependent on the effort and expense a hacker is willing to invest in defeating the encryption, replacement of encryption keys may employed in some embodiments of the invention. The use of random number generation, with 25, 50, 60, 80, 100, 120, 128, 156, 180 or more bits clearly provides the capacity to exceed the capability of hackers to access the codes. This is particularly true where the random number generation is unique to individual machines, and can even be unique to each play or boot-up of the game. Digital signatures in some embodiments are valid only for a predetermined period of time, and in further embodiments have an associated date of expiry after which they may no longer be used. Such methods can also be used in various embodiments of the invention to license games for use for a certain period of time, after which they will not be properly verified due to expiry of the encryption keys used for data verification. Because hash functions typically produce hash values that are dependent entirely on the data being hashed, embodiments of the invention which incorporate expiry and replacement of reference hash values also require reissuance of modified data to produce a different hash value. For example, minor bug fixes, addition of new features, or any other small change in the data comprising a gaming program will be sufficient to produce a different reference hash value upon hashing the edited program data, resulting in an updated reference hash value corresponding to the updated data.

Other embodiments use a variety of keys among various computerized wagering games and game producers, reducing the risk and therefore the value of successfully defeating an encryption key. For example, a game producer in one embodiment employs a different digital signature for each customer of its computerized wagering games, ensuring that defeating the encryption key on a single game system affects a limited number of games. In another embodiment, a regulatory agency may change keys with which it signs games on a periodic basis, so that a successful hack of the keys used to sign the data results in potential compromise of only a limited and identifiable number of games. It will be obvious to one skilled in the art that many variations on key replacement and expiry policies exist, all of which are considered within the scope of the present invention.

The invention provides an architecture and method for a gaming-specific platform that features secure storage and verification of game code and other data, provides the ability to securely exchange data with a computerized wagering gaming system, and does so in a manner that is straightforward and easy to manage. Some embodiments of the invention provide the ability to identify game program code as certified or approved, such as by the Nevada Gaming Regulations Commission or other regulatory agency. The invention provides these and other functions by use of encryption, including digital signatures and hash functions as well as other encryption methods.

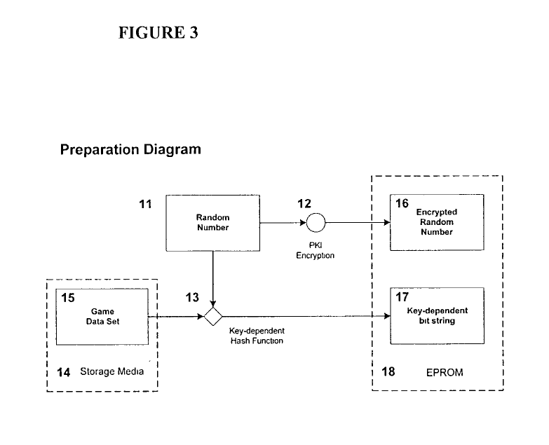

FIG. 3 is a block diagram illustrating one exemplary embodiment of a gaming system according to the present invention. The gaming system block diagram is representative of the performance of the preparation and authentication programs used in the gaming system shown in FIG. 1 and FIG. 2, and previously described herein. The gaming system includes a unique system and method for preparing a game data set 15 capable of authentication and authenticating a game used in the gaming system. The gaming system preparation sequence 15 comprises providing the Game Data Set 15 in a storage media 14, generating a random number 11, treating both the Game Data Set 15 and the random number 11 with a hash function (here a key-dependent hash function 13) to form a single key-dependent bit string 17 that here is shown to be stored in EPROM 18. The random number 11, either before or after or contemporaneously with the treatment, is separately treated (e.g., encrypted) with a PKI (private key) encryption 12. This encryption produces an encrypted random number 16 which also is stored, and here is shown as being stored on EPROM 18.

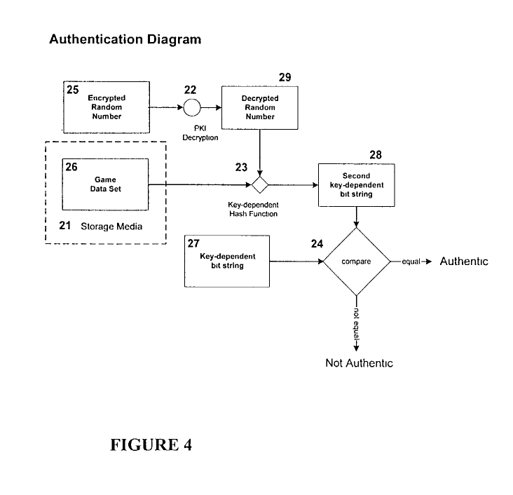

After this preparation sequence has been performed and the encrypted random number and the first bit string (e.g., the first key-dependent bit string 17) has been stored (e.g., on EPROM), the authentication sequence of FIG. 4 may be performed. In the authentication program, the encrypted random number 25 is decrypted with the PKI decryption (public key) 22 and the original random number 29 is generated. The same Game Data Set 26 that has been used to establish the first bit string (e.g., the first key-dependent bit string 17 of FIG. 3) is then treated with the decrypted random number 29 with the same hash function 23 used in treating the game data set 15 and random number 11 used in the preparation step of FIG. 3, that hash function identified in the preparation step as key-dependent hash function 13. The result of this treatment in the authentication sequence is a second bit string (in this case a second key-dependent bit string 28). This second bit string 28 is then compared with the first bit string (e.g., here, the key-dependent bit string 27). If the comparison 24 shows that the two bit strings are ‘equal,’ the game data set has been confirmed or approved as authentic. If the comparison 24 shows that the two bit strings are ‘unequal,’ then the game data set has been denied or disproved as authentic, and has been found to be corrupt or unreliable.

Components of the present invention can be implemented in hardware via a microprocessor, programmable logic, or state machine, in firmware, or in software within a given device. In one preferred embodiment, one or more components of the present invention reside in software. Components of the present invention may also reside in software on one or more computer-readable mediums. The term computer-readable medium as used herein is defined to include any kind of memory, volatile or nonvolatile, such as floppy disks, hard disks, CD-ROMs, flash memory, read-only memory (ROM), and random access memory (RAM). In addition, gaming system 100 can employ a microprocessor embedded system/appliance incorporating tailored appliance hardware and/or dedicated signal purpose hardware.

In one aspect, the gaming system may include a gaming control system, gaming system interface, and gaming system devices. Gaming control systems include computers or controllers, volatile memory, and nonvolatile memory. A controller includes memory and nonvolatile RAM (NVRAM). In one aspect, memory is random access memory. In one aspect, the random access memory is dynamic random access memory (DRAM). The nonvolatile random access memory includes a battery backup for maintaining data stored in memory upon loss of power. In one embodiment, NVRAM 308 is used for storing crucial gaming data, such as slot machine reel settings, payoff percentages, and credits.

In one embodiment, program memory may be stored on a read/writeable, nonvolatile memory. In one aspect, the writeable memory may be flash memory. One suitable nonvolatile memory is commercially available under the trade name “Compact Flash” commercially available from a variety of vendors. Other nonvolatile memory suitable for use with the present invention will become apparent to one skilled in the art after reading the present application.

Nonvolatile memory may be used to store a game data set, which is defined to include game specific code or gaming program files. Exemplary game specific codes includes game code, game data, game sound, game graphics, game configuration files, or other game specific files. The game specific code or program files are directed to specific type of games run on the gaming system, such as Blackjack, poker, video slot machines, or reel slot machines. In one embodiment, nonvolatile memory is read only memory (ROM) such as an EPROM. Nonvolatile memory is used to store gaming system operating code. Upon power up or operation of the gaming system, the gaming system operating code and game data sets are transferred into memory, preferably volatile memory, for fast access by controller for operation of the gaming system. During operation of the gaming system, controller interfaces with gaming system devices via gaming system for operation of the gaming system. A gaming system interface may include network interface, network computer, and network connection previously detailed herein. A gaming system device may include mechanical, electrical, hardware, software or video devices, such as pushbuttons, joystick, pull arm, token or slot device, coin tray, video screen and speakers previously detailed herein.

In one aspect, the hash function may be a SHA hash function. Other suitable hash functions include MD5, SNEFRU, HAVAL and N-HASH. Other hash functions which are suitable for use in the verification process according to the present invention will become apparent to one skilled in the art after reading the present application. The hashed output or message values are stored in a storage system. The storage system may include message digest being stored in RAM or in VRAM or other suitable storage system which is part of gaming system.

During operation of the gaming system, the gaming data set may be continuously verified to determine that no change has occurred in the game data set. In one aspect, the game data set is verified one file or data subset at a time. If no match occurs the game enters into an error mode, is terminated, and/or gaming personnel are notified. If a match occurs the next program file of game data set is verified in a similar manner. As such, the game data set is continuously verified during operation of the gaming system. Another aspect, the game data set may be verified using the verification process according to the present invention at desired time intervals or upon the occurrence of a desired event, such as the start of each game played, door open and door close events, or large payouts such as jackpots.

The gaming system according to the present invention provides a unique system and method for preparing a game data set capable of authentication and authenticating a game used in the gaming system. The gaming system includes a process which securely verifies that the gaming set, including program files have not been altered, either intentionally or unintentionally, which could result in the changing of the outcome of a game played on the gaming system. The verification or authentication of the apparatus content (e.g., the casino game data set, and any and all information stored within the system) can be performed at various times. The process may be performed during boot-up, upon initiation of any game play or game step, during rest times between game play, upon awards, upon special awards, upon payouts, upon shut down, or at any other time during use or rest of the apparatus. In one aspect, the present invention provides for continuous verification of the gaming system during operation of the gaming system.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

What is claimed is:

1. A computerized wagering game apparatus, comprising:
a computerized game controller having a processor, memory, random number generator and nonvolatile storage and operable to control the computerized wagering game;
stored game data;
wherein a previously encrypted random number is decrypted and stored in memory.

2. The computerized wagering game apparatus of claim 1, wherein the a first bit stream is stored in the nonvolatile storage.

3. The computerized wagering game apparatus of claim 2 wherein an authentication program is present that requires, in any order, the following steps to be performed by the processor:
decrypting the encrypted random number to regenerate the random number;
hashing a) the random number regenerated from the encrypted random number and b) the casino game data set to produce a second bit stream;
comparing the first bit stream and the second bit stream.

4. The computerized wagering game apparatus of claim 3 wherein the resulting hash value is a result of hashing with a one-way hash function.

5. The computerized wagering game apparatus of claim 4 wherein the program directs that: i) if the first bit stream and the second bit stream are identical, the casino game data set is confirmed, and ii) if the first bit stream and the second bit stream are different, the casino game data set is identified as defective.

6. The computerized wagering game apparatus of claim 1 wherein the casino game data set and random number are hashed with a key-dependent hash function.

7. The computerized wagering game apparatus of claim 3 wherein the casino game data set and random number are hashed with a key-dependent hash function.

8. The computerized wagering game apparatus of claim 4 wherein the casino game data set and random number are hashed with a key-dependent hash function.

9. The computerized wagering apparatus of claim 4 wherein the game data is hashed with the random number after loading the gaming program into random access memory and the second bit stream is compared to the first bit stream in a continuously executing program thread executing on the computerized game controller

10. The computerized wagering game apparatus of claim 4 wherein the computerized wagering game system is brought to a tilt state if the second bit stream is not the same as the first bit stream.

11. The computerized wagering game apparatus of claim 1 wherein the first bit stream is stored in a nonvolatile memory comprising a part of the computerized wagering game apparatus.

12. The computerized wagering game system of claim 4 wherein a system handler application loads and executes encryption functions which are subsequently used to securely load other game data from nonvolatile storage.

13. The computerized wagering game apparatus of claim 4 further comprising a nonvolatile memory storing a public key corresponding to a private key used to encrypt the random number.

14. The computerized wagering game apparatus of claim 1 wherein the computerized game controller is a general-purpose computer.

15. The computerized wagering game apparatus of claim 1 further comprising a network interface connecting the computerized wagering game apparatus to a networked computer.

16. A method for securing data on a computerized wagering game apparatus, comprising preparation of game data by a process comprising:
generating a random number;
encrypting the random number to form an encrypted random number;
hashing the random number with a casino game data set to generate a first bit string; and
storing the encrypted random number and the first bit string in memory.

17. The method of claim 16 wherein hashing is performed with a key-dependent hash function.

18. The method of claim 16 wherein the encryption is performed with a private key function.

19. The method of claim 16 wherein to authenticate casino game data, the encrypted random number is decrypted to provide a decrypted random number, the decrypted random number is hashed with the casino game data set to provide a second bit string.

20. The method of claim 19 wherein the second bit string is compared with the first bit string, and i) if the first bit stream and the second bit stream are identical, the casino game data set is confirmed, and ii) if the first bit stream and the second bit stream are different, the casino game data set is identified as defective.

21. The method of claim 19 wherein at least some data used in or resulting from encrypting, hashing, decrypting or comparing is communicated via the computerized wagering game apparatus over a network.

22. The method of claim 21, wherein the data communicated over the network comprises instructions to control the operation of the computerized wagering game.

23. The method of claim 21 wherein the data communicated over the network comprises shared objects for execution on the computerized wagering game.

24. The method of claim 21 wherein the data communicated over the network comprises data reported by the computerized wagering game.

25. The method of claim 19 wherein hashing is performed with a one-way hash function.

26. The method of claim 19 further comprising comparing the second bit string to the first bit string to ensure that the data has not changed since calculation of the reference hash value.

27. The method of claim 19 wherein the first bit string is stored in nonvolatile memory that comprises a part of the computerized wagering game apparatus.

28. The method of claim 25 wherein hashing the stored data with a one-way hash function comprises:
loading the casino game data set into random access memory;
hashing the stored data and the random number with a one-way hash function in a continuously executing thread or separate hardware device to form the second bit string; and
comparing the second bit string to the first bit string in a continuously executing thread or separate hardware device to ensure that the casino game data has not changed since calculation of the first bit string.

29. The method of claim 28 further comprising bringing the computerized wagering game to a tilt state if the second bit string is not the same as the first bit string.

30. The method of claim 28 wherein hashing is effected with a one-way key-dependent hash function.

31. The method of claim 28, wherein the computerized wagering game apparatus comprises a general-purpose computer.

32. A computerized wagering game apparatus, comprising:
a computerized game controller having a processor, memory and nonvolatile storage and operable to control the computerized wagering game;
gaming program code, an encrypted random number, and a first bit string resulting from hashing of the unencrypted random number and gaming program code with a hash function, the first bit string stored in the nonvolatile storage, and
an authentication program stored in nonvolatile storage, wherein the authentication program, when executed, verifies that the gaming program code in nonvolatile storage has not changed by means of generating a second bit string by decrypting the encrypted random number to provide a resulting decrypted random number; hashing with the hash function the decrypted random number and the gaming program code to produce a second bit string, and comparing the first bit string and the second bit string to verify that they are identical.

33. The method of claim 32 wherein the hash function is a one-way hash function.

34. The method of claim 32 wherein the encryption used to encrypt the random number comprises a private key encryption program.

35. The method of claim 33 wherein the encryption used to encrypt the random number comprises a private key encryption program.

36. A gaming system comprising:
a nonvolatile memory;
an encrypted random number file stored in the nonvolatile memory;
a hashed value comprising a first bit string resulting from hashing the random number and a casino game data set;
a gaming controller, wherein the gaming controller operates to decrypt the encrypted random number and authenticate the gaming program files during operation of the gaming system.

37. The gaming system of claim 36 wherein gaming system devices are in communication with the gaming controller via a gaming system interface.

38. The system of claim 36 wherein the nonvolatile memory is writeable memory.

39. The system of claim 36 wherein the nonvolatile memory is flash memory.

40. A computer-readable medium having computer-executable instructions for performing a method of preparing a game data set capable of authentication comprising:
providing a game data set;
providing a random number;
encrypting the random number;
hashing the game data set and the random number to provide a first bit string; and
storing the first bit string and the encrypted random number.

41. The computerized wagering apparatus of claim 4 wherein the game data is hashed within a separate component in the wagering apparatus.

42. The computerized wagering apparatus of claim 41 wherein the separate component comprises an in-circuit validator.

43. The method for securing data on a computerized wagering game apparatus of claim 16 wherein a second random number is provided, the random number is encrypted to form a second encrypted random number; the second random number is hashed along with the casino game data set to generate a second bit string; and the encrypted second random number and the second bit string are stored in memory.

44. The method of securing data according to claim 43 wherein verification is effected by a process that includes comparing the first encrypted random number and the second encrypted random number to determine a mathematical relationship between them.

45. The method of claim 44 wherein verification includes a second iteration of hashing the first random number with the stored casino game data set and hashing the second random number with the stored casino game data set, comparing the second iteration of the first encrypted random number and the second iteration of the second encrypted random number and comparing a mathematical relationship between the second iteration encrypted random numbers with the mathematical relationship between the first encrypted random number and the second encrypted random number.
